(19) United States
(12) Patent Application Publication
(10) Pub. No.: US 2022/0076244 A1
(43) Pub. Date: Mar. 10, 2022

(54) STORING CUSTOMER IDENTIFIER IN A SMART DEVICE FOR ENABLING ENGAGEMENT WITH AN ENTERPRISE

(71) Applicant: [24]7.ai, Inc., San Jose, CA (US)

(72) Inventors: Pallipuram V. Kannan, San Jose, CA (US); Manoj Rajshekar, Fremont, CA (US)

(21) Appl. No.: 17/016,054

(22) Filed: Sep. 9, 2020

(51) Int. Cl. G06Q 20/36; G06Q 20/32; G06Q 20/20; G06Q 20/40; G06Q 30/06; G06Q 30/00; G06F 16/23; G06K 19/07; G06K 19/06; G06Q 20/38; H04M 1/725; H04L 12/58

(52) U.S. Cl. CPC G06Q 20/363; G06Q 20/326; G06Q 20/3674; G06Q 20/202; G06Q 20/40145; G06Q 30/0613; H04L 51/046; G06F 16/2379; G06K 19/0723; G06K 19/06037; G06Q 20/385; H04M 1/72525; G06Q 30/0185

(57) ABSTRACT

A method and server system for facilitating customer engagement with an enterprise is disclosed. The server system receives a signal indicative of a request for registering a customer with an enterprise. In response to the receipt of the request, the server system generates an enterprise virtual customer identifier (EVCI), which is configured to map the customer uniquely to information related to a profile of the customer. The EVCI is transmitted to the customer on successful registration of the customer. The EVCI is stored in at least one digital wallet application installed in an electronic device associated with the customer. The stored EVCI in the digital wallet application is configured to facilitate at least one engagement with the enterprise over one or more messaging channels.

### TECHNICAL FIELD

The present technology generally relates to interactions between enterprises and customers of the enterprises and, more particularly to, methods and systems for facilitating customer engagement with an enterprise by using a customer identifier stored in a smart device of a customer.

### BACKGROUND

Many enterprises, nowadays, use software applications to engage with existing and potential customers. A customer may download an enterprise application from an online application store onto the electronic device associated with the customer. The downloaded application may enable the customer to view latest product offerings from the enterprise, engage in purchase transactions, make payments, troubleshoot product related technical issues, and the like. The enterprise may also benefit from the increased engagement with customers in terms of increased sales and increased awareness of enterprise offerings.

Though an application may serve to assist the customer in engaging with the enterprise, a customer may be reluctant to download the application of the enterprise onto the electronic device associated with the customer. It is understood that a customer may interact with several enterprises for a variety of customer needs, and as such, installing an application for each enterprise may not be prudent or feasible for the customer. In addition to requiring additional effort in accessing and downloading the application from the application store, the downloaded application may also consume storage space and seek access to other information, such as contacts information, stored on the electronic device. Furthermore, keeping track of login credentials/passwords and authenticating personal identity for each financial and non-financial enterprise engagement may be cumbersome for the customer. For the aforementioned reasons, the customer may avoid installing the enterprise application onto the electronic device(s) associated with the customer.

There is a need to overcome drawbacks of the existing solutions and enable potential and existing customers of an enterprise to engage with the enterprise in a secure and seamless manner.

### SUMMARY

In an embodiment of the invention, a computer-implemented method for facilitating customer engagement with an enterprise is disclosed. The method receives, by a server system, a signal indicative of a request for registering a customer with an enterprise. In response to the receipt of the request, the method generates by the server system, an enterprise virtual customer identifier (EVCI) configured to uniquely map the customer to information related to a profile of the customer. The method transmits, by the server system, the EVCI to the customer on successful registration of the customer. The method causes, by the server system, storage of the EVCI in at least one digital wallet application installed in an electronic device associated with the customer. The stored EVCI in the at least one digital wallet application is configured to facilitate at least one engagement with the enterprise over one or more messaging channels.

In an embodiment of the invention, a server system for facilitating customer engagement with an enterprise is disclosed. The server system includes a processing module and a memory. The memory stores instructions. The processing module is configured to execute the instructions and thereby cause the server system to receive a signal indicative of a request for registering a customer with an enterprise. In response to the receipt of the request, the server system generates an enterprise virtual customer identifier (EVCI) configured to uniquely map the customer to information related to a profile of the customer. The server system transmits the EVCI to the customer on successful registration of the customer. The server system causes storage of the EVCI in at least one digital wallet application installed in an electronic device associated with the customer. The stored EVCI in the at least one digital wallet application is configured to facilitate at least one engagement with the enterprise over one or more messaging channels.

In an embodiment of the invention, an electronic device is disclosed. The electronic device includes a processor and a memory. The memory stores instructions. The processor is configured to execute the instructions and thereby cause the electronic device to receive an enterprise virtual customer identifier (EVCI) from a server system associated with an enterprise. The electronic device stores the EVCI in at least one digital wallet application installed in the electronic device. The electronic device receives an input from the customer for retrieving the stored EVCI for initiating an engagement with the enterprise. In response to the input, the electronic device authenticates the customer using native authentication means implemented on the electronic device for authenticating transactions using the at least one digital wallet application. The electronic device facilitates the engagement with the enterprise over one or more messaging channels subsequent to successful authentication of the customer. The authentication is extended to at least one messaging channel from among the one or more messaging channels for facilitating the engagement of the customer with the enterprise.

### BRIEF DESCRIPTION OF THE FIGURES

FIG. 1 is an example representation of an environment related to at least some example embodiments of the invention;

FIG. 2 is a sequence flow diagram illustrating a process for generating an EVCI, in accordance with an embodiment of the present invention;

FIG. 3 shows a representation for illustrating a generation of an example EVCI, in accordance with an embodiment of the invention;

FIG. 4 shows an example representation of a messaging notification for illustrating the addition of an EVCI to a digital wallet application installed in the electronic device of the customer, in accordance with an embodiment of the invention;

FIG. 5 shows an example representation of a User Interface (UI) associated with a digital wallet application for illustrating the storage of the EVCI in the digital wallet application, in accordance with an embodiment of the invention;

FIG. 6 is a sequence flow diagram illustrating a process for facilitating customer engagement with an enterprise using the EVCI stored in the digital wallet application, in accordance with an embodiment of the invention;

FIG. 7 shows an example representation for illustrating the use of the stored EVCI in facilitating customer engagement with the enterprise, in accordance with an embodiment of the invention;

FIG. 8 shows an example representation for illustrating the use of the stored EVCI in facilitating customer engagement with the enterprise, in accordance with another embodiment of the invention;

FIG. 9 illustrates a flow diagram of a method for facilitating customer engagement with an enterprise, in accordance with an embodiment of the invention;

FIG. 10 illustrates a block diagram representation of a server system capable of implementing various embodiments of the present invention; and

FIG. 11 illustrates an electronic device capable of implementing at least some embodiments of the present invention.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

### Overview

Various embodiments of the present invention provide a method and a system for facilitating customer engagement with an enterprise by using a customer identifier stored in a smart device of the customer.

An enterprise may offer products, services and/or information to existing and potential users of such offerings. The users of enterprise offerings are also referred to herein as ‘customers’ of the enterprise.

In many scenarios, customers may wish to register with an enterprise to avail access to the enterprise messaging channels, to view new product/service offerings, to view latest information, to make payments for services availed or for products purchased, and the like. To register with an enterprise, a customer may visit an enterprise channel, such as a website, and provide a request to register an identity of the customer with the enterprise.

In at least one embodiment, a server system is disclosed. The server system is configured to receive the customer's request for registration on account of being in operative communication with an enterprise server. In response to the customer's registration request, the server system is configured to generate an enterprise virtual customer identifier (EVCI) to uniquely map the customer to a profile of the customer stored in a database associated with the enterprise server. The server system transmits the EVCI to an electronic device associated with the customer. In at least one embodiment, the electronic device may be a smart device. The server system further causes storage of the EVCI in one or more digital wallet applications installed on the electronic device.

The stored EVCI is capable of enabling a customer to engage with an enterprise. More specifically, the EVCI serves as a single pointer to the customer's profile information, which may include details related to customer's preferences, payment cards, previous customer interactions, and the like. The profile information may enable customer engagement with the enterprise in several ways. For example, the payment card information stored in the profile of the customer, and fetched using the EVCI, may be used to make payments on online portals, POS terminals, and the like. Similarly, the EVCI may be used to enable the customer to interact with a customer support representative, also known as an agent', of the enterprise. The information related to the preferences of the customer may be used to personalize an engagement experience of the customer on the enterprise website or during agent conversations.

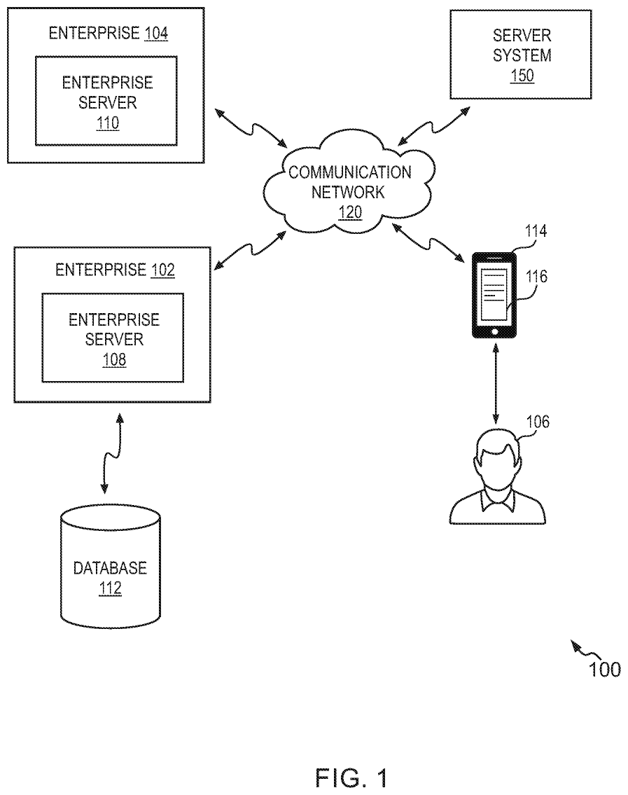

Moreover, on account of being stored in the digital wallet application in the electronic device, the EVCI can be accessed only on successful authentication of an identity of the user using native authentication means, such as face recognition, finger print recognition, and a One-Time Password (OTP). Thus, the customer identifier stored in the smart device of the customer may facilitate customer engagement with the enterprise while precluding the need to install enterprise applications or the need to maintain separate authentication means for engaging with the enterprise. The generation of the EVCI and the use of the EVCI for facilitating customer engagement with an enterprise is explained in further detail with reference to FIGS. 1 to 11.

FIG. 1 is an example representation of an environment 100 related to at least some example embodiments of the invention.

The environment 100 is exemplarily depicted to include two enterprises, such as an enterprise 102 and an enterprise 104. The term ‘enterprise’ as used throughout the description may refer to a corporation, an institution, or even a small/medium sized company offering products, services, or information to customers. For example, the enterprise may be a banking enterprise, an educational institution, a financial trading enterprise, an aviation company, a consumer goods enterprise, an insurance company, a telecommunication enterprise, or any such public or private sector enterprise.

Each enterprise may offer products, services and/or information to one or more existing and potential customers. One such example customer is shown as customer 106. In addition to offering products, services and/or information, each enterprise may offer customer service/customer support in form of a plurality of human agents and automated agents who are trained to engage in interactions with the customers of the enterprise to resolve the customer queries and, in general, provide any desired assistance to the customers. For purposes of the description, the terms ‘customer service centre’, ‘customer support center’, ‘customer care center’ imply a facility, in which a plurality of human agents, a plurality of automated agents, and several self-serve systems are deployed for providing assistance to the customers. Such a facility is hereinafter referred to as a customer care center. The customer care center may include a plurality of Interactive Voice Response (IVR) systems, a plurality of human agents, a plurality of automated/virtual agents such as chatbots, and a plurality of self-serve systems. The customer care center is not shown in FIG. 1.

Each enterprise is depicted to be associated with an enterprise server. For example, the enterprise 102 is depicted to be associated with an enterprise server 108 and the enterprise 104 is depicted to be associated with an enterprise server 110. Although each enterprise is depicted to be associated with a single enterprise server, an enterprise may be associated with several enterprise servers. The enterprise servers may be configured to be in operative communication with several databases, and in conjunction with the databases, the enterprise servers may host enterprise websites, record customer relation management (CRM) information of respective customers, track customer interactions with agents deployed at the customer care center, and the like. An example database 112 is shown to be in operative communication with the enterprise server 108 for illustration purposes. The database 112 may store CRM information, data related to customer interactions with agents deployed in the customer care center, and the like. In addition to an enterprise server and a database, each enterprise may be associated with a server system, such as the server system 150 configured to facilitate customer engagement with respective enterprises, as will be explained in detail later.

The customer 106 is depicted to be associated with an electronic device 114 capable of facilitating communication with remote entities over a communication network 120. In one embodiment, the electronic device 114 is a smart device. The term ‘smart device’ as used hereinafter refers to a device, which in addition to enabling communication with remote entities, is capable of several other functions of a computer, such as having a touchscreen interface, having the capability to access Internet, and including an operating system capable of operating downloaded apps. Although the electronic device 114 is depicted to be embodied as a smartphone, the electronic device 114 may correspond to any user device capable of connecting to a communication network, such as the communication network 120. Some non-limiting examples of the electronic device 114 include a laptop, a desktop computer, a tablet computer, a smart wearable device, and the like. The electronic device 114 may include several software applications installed therein. In one embodiment, the electronic device 114 may include one or more digital wallet applications installed therein. The digital wallet application 116 may store information related to one or more payment cards, such as credit cards, debit cards, etc., travel cards, identity cards, and the like. An example digital wallet application 116 included in the electronic device 114 is shown in FIG. 1 for illustration purposes.

The communication network 120 may be embodied as a wired network, a wireless network, or a combination of wired and wireless networks. Some non-limiting examples of the wired network include Ethernet, Local Area Network (LAN), Optical Fiber network, or combinations, thereof. Some non-limiting examples of the wireless network include a cellular network, a wireless LAN (WLAN) network, a Bluetooth or a ZigBee network, and combinations thereof An example of a combination of a wired network and a wireless network is the Internet. Various entities in the environment 100, such as the server system 150, the electronic device 114, and the enterprise servers 108 and 110 may connect to the communication network 120 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, and the like.

The server system 150 may be embodied as at least one computing device in communication with the communication network 120. The server system 150 may include a processing module and a memory, and the processing module in conjunction with the instructions stored in the memory may be configured to facilitate engagement of customers, such as the customer 106, with one or more enterprises, such as the enterprises 102 and 104, as will be explained in detail later.

In one example scenario, the customer 106 may wish to access enterprise channels or seek to purchase products or avail services offered by the enterprise 102. To initiate such engagement with the enterprise 102, the customer 106 may have to register a personal identity with the enterprise 102. To that effect, the customer 106 may use the electronic device 114 to access an enterprise online interface, such as for example, an enterprise website or an enterprise mobile application interface, and fill out one or more registration form fields with information, such as the customer's name, address, age, sex, payment card information, preferences, contact information, etc. Such information provided by the customer 106 may be embodied in form of a signal and sent to the enterprise server 108 for registering the identity of the customer 106. If the customer 106 has previously purchased products of the enterprise 102 or interacted with agents of the enterprise, such information may be stored in the database 112 associated with the enterprise 102. On receiving the signal indicative of the customer's request for registration, the information provided by the customer 106 may be added to the stored information to create a profile of the customer 106. In other words, a profile of the customer 106 may be generated as part of the registration process. If the customer 106 is a new user, the information provided by the customer 106 may be used to create the profile of the customer 106. The created profile of the customer 106 may include content, such as information related to at least one of the customer's personal information, products owned by the customer 106, services undertaken by the customer 106, one or more locations associated with the customer 106, one or more customer preferences, interactions of the customer 106 with enterprise website and with agents of the enterprise 102. On successful creation of the customer profile, the enterprise 102 may deem the registration process to be completed.

The server system 150, on account of being in operative communication with the enterprise server 108, may receive the signal indicative of the customer's request for registration. The enterprise server 108 may also communicate the successful completion of the customer registration process and a pointer to the profile of the customer 106 to the server system 150.

The server system 150 is configured to generate an enterprise virtual customer identifier (EVCI) in response to the receipt of the signal indicative of the request for registering the customer 106 with the enterprise 102. The server system 150 also creates a link between the generated EVCI and the profile of the customer 106 to uniquely map the EVCI with the profile of the customer 106.

The server system 150 is further configured to transmit the EVCI along the notification of the successful registration to the electronic device 114 of the customer 106. The server system 150 further causes storage of the EVCI in the digital wallet application, such as the digital wallet application 116. Whenever the customer 106 wishes to retrieve the stored EVCI for engaging with the enterprise 102 again, a customer identity is authenticated using native device authentication means associated with authentication of data stored in the digital wallet application 116. The successful authentication is extended to an enterprise messaging channel and the EVCI is used to identify the customer 106 and facilitate customer engagement with the enterprise 102.

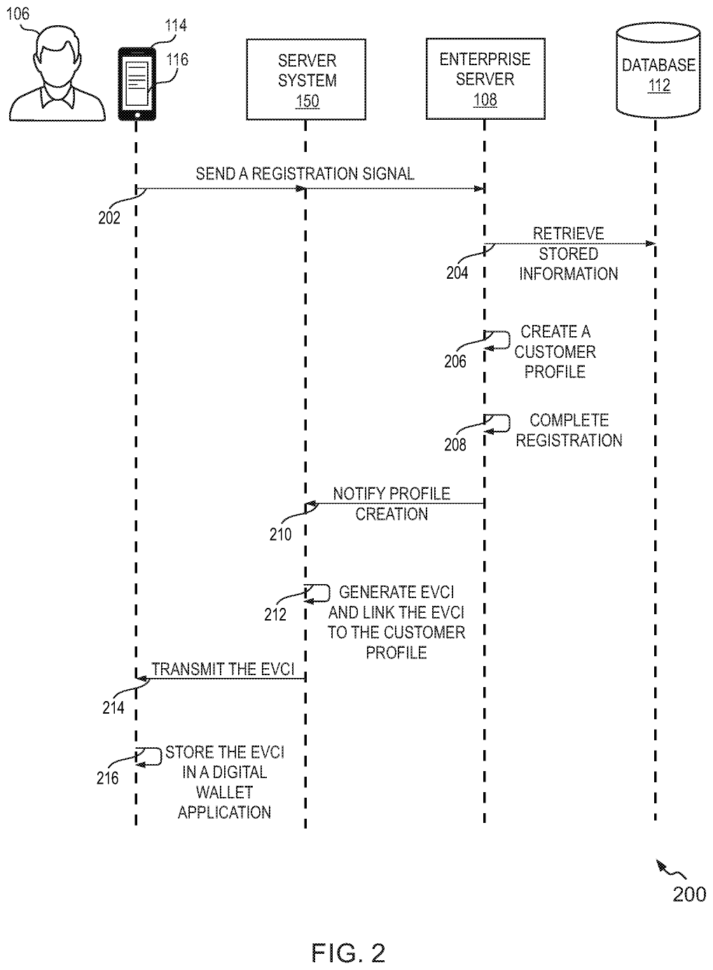

Although the generation of the EVCI is explained with reference to the enterprise 102, a similar EVCI may be generated for each enterprise for mapping the customer 106 to profile information stored with respective enterprise. Alternatively, a single EVCI may be generated for one customer 106 and custom profile segments of the customer 106 may be activated based on the enterprise context. Although the EVCI is mentioned to be generated as part of the registration process, in at least some embodiments, the EVCI may also be generated as part of an engagement between the customer 106 and the enterprise 102. For example, during the course of an on-going conversation between the customer 106 and an agent of the enterprise 102 the agent, using the services of the server system 150, may send a message to the customer 106 or initiate a co-browsing web session with the customer 106 to enable the customer 106 to set-up a profile and to register a personal identity. The EVCI may then be provided to the customer 106 on successful completion of the registration. The customer 106 may further be requested to store the EVCI in the digital wallet application 116 for enabling future engagements with the enterprise 102. A sequence flow diagram illustrating the process flow for generation of the EVCI is shown in FIG. 2.

FIG. 2 is a sequence flow diagram 200 illustrating a process for generating an EVCI in accordance with an embodiment of the present invention. The sequence of operations of the sequence flow diagram 200 may not be necessarily executed in the same order as it is presented. Further, one or more operations may be grouped together and performed in form of a single step, or one operation may have several sub-steps that may be performed in parallel or in a sequential manner. The process illustrated by the sequence flow diagram 200 starts at 202.

At 202, the customer 106 uses the electronic device 114 to send the signal indicative of the request to register the identity with the enterprise 102 (shown in FIG. 1). As explained with reference to FIG. 1, the customer 106 may wish to access enterprise channels or seek to purchase products or avail services offered by the enterprise 102. To initiate such engagement with the enterprise 102, the customer 106 may have to register a personal identity with the enterprise 102. To that effect, the customer 106 may use the electronic device 114 to access an enterprise online interface, such as for example, an enterprise website or an enterprise mobile application interface, and fill out one or more registration form fields with information, such as the customer's name, address, age, sex, payment card information, preferences, contact information, etc. Such information provided by the customer 106 may be embodied in form of a signal and sent to the enterprise server 108 for registering the identity of the customer 106.

The signal sent by the electronic device 114 may be received by the enterprise server 108. Moreover, the server system 150 may also receive the signal on account of being in operative communication with the enterprise server 108.

At 204, the enterprise server 108 may check the database 112 to determine whether the customer 106 has previously engaged with the enterprise 102 or not. If the customer 106 has previously engaged with the enterprise 102, the enterprise server 108 may retrieve the stored information related to the customer 106 from the database 112.

At 206, the enterprise server 108 may create a profile of the customer 106. The created profile of the customer 106 may include content, such as information related to at least one of the customer's personal information, products owned by the customer 106, services undertaken by the customer 106, one or more locations associated with the customer 106, one or more customer preferences, interactions of the customer 106 with enterprise website and with agents of the enterprise 102. On successful creation of the customer profile, the enterprise 102 may deem the registration process to be completed at 208.

At 210, the enterprise server 108 may notify the server system 150 of the successful completion of the registration process and the creation of the profile of the customer 106.

At 212, the server system 150 generates an enterprise virtual customer identifier (EVCI) in response to the request for registration of the customer 106 with the enterprise 102 and also link the generated EVCI with the information related to the profile of the customer 106.

At 214, the server system 150 transmits the EVCI to the electronic device 114 associated with the customer 106.

At 216, the EVCI is caused to be stored in the digital wallet application 116 installed in the electronic device 114. The process illustrated by the sequence flow diagram 200 ends at 216.

As explained with reference to FIG. 1, in at least some embodiments, the EVCI may also be generated as part of an engagement between the customer 106 and the enterprise 102. For example, during the course of an on-going voice conversation between the customer 106 and an agent of the enterprise 102, the agent may enable the customer 106 to set-up a customer profile and to register a personal identity. In one illustrative example, the customer 106 may be engaged in a voice interaction with an agent of the enterprise 102 to resolve a concern. During the conversation, the agent may provide a messaging notification, such as an SMS or an instant message, to the customer 106 on the electronic device 114 to set-up a customer profile and to register the personal identity of the customer 106. On completion of the registration process, the agent using the services of the server system 150 may provide the EVCI to the customer 106. The EVCI is then stored in the digital wallet application 116 installed in the electronic device 114. In another illustrative example, the agent may also initiate a co-browsing session with the customer 106 during the conversation with the customer 106. The co-browsing session may be initiated to assist the customer 106 in setting up a customer profile and thereafter provide the EVCI to the customer 106 on completion of the registration process. The EVCI is then stored in the digital wallet application 116 installed in the electronic device 114.

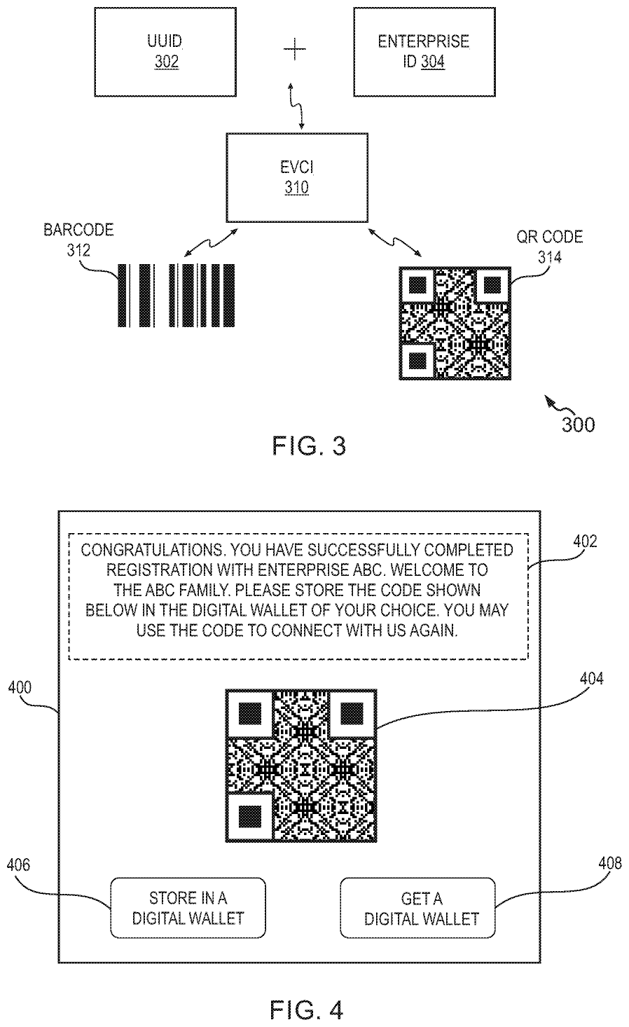

FIG. 3 shows a representation 300 for illustrating a generation of an example EVCI in accordance with an embodiment of the invention.

As explained with reference to FIG. 1, the server system 150 is in operable communication with multiple enterprises via the enterprise servers associated with the respective enterprises. The server system 150 may assign a unique enterprise ID for each associated enterprise. Further, the server system 150 may include instructions in the memory for generating a unique random number for each customer requesting registration from an associated enterprise, or for each customer engaging in interaction with the enterprise, which serves as the universally unique identification (UUID) for the customer. In one embodiment, the server system 150 generates the EVCI by combining the enterprise ID and the UUID as exemplarily shown in FIG. 3. More specifically, the representation 300 depicts a UUID 302 generated in response to a customer registration request for registering the customer with an enterprise. The enterprise may be associated with the enterprise ID 304. The server system 150, shown in FIGS. 1 and 2, may be configured to combine the UUID 302 and the enterprise ID 304 to generate EVCI 310. It is noted that though the UUID 302, the enterprise ID 304 and the EVCI 310 are exemplarily depicted as blocks in the representation 300, each of the UUID 302, the enterprise ID 304 and the EVCI 310 may include numbers, alphabets, special characters or any combinations thereof. In one simplified example, the enterprise ID of enterprise ABC may correspond to ‘0040’, whereas the UUID generated for the customer may correspond to 1555 6789 1009. The server system 150 may combine the enterprise ID and the UUID to generate the EVCI as 0040 1555 6789 1009. It is understood that the combination may not be limited to simple concatenation of the numeral strings and that various combinations, such as interleaved concatenation etc., may be possible.

In one embodiment, the server system 150 is configured to represent the generated EVCI 310 using a one-dimensional barcode such as barcode 312 or a two-dimensional Quick Response (QR) code, such as QR code 314. It is noted that the expression of the EVCI 310 in form of the barcode 312 or the QR code 314 is mentioned herein for illustration purposes and that the EVCI 310 may be expressed in other machine readable forms, such as Near Field Communication (NFC) tag, for example. The EVCI 310 is readable by barcode scanners, QR code readers, camera scanner applications and such other means capable of reading machine readable codes.

The server system 150 may further link the information related to the profile of the customer to the EVCI 310 expressed in the form of barcode 312 or the QR code 314 to uniquely map the customer to the information related to a profile of the customer. The EVCI 310 expressed in the form of a machine readable code, such as the barcode 312 or the QR code 314, may be transmitted by the server system 150 to the electronic device associated with the customer using at least one of a Short Message Service (SMS), an Electronic Mail (E-mail), a mobile application notification, and an instant messaging notification. The server system 150 may also cause the storage of the EVCI 310 in a digital wallet application installed in the electronic device of the customer, as will be explained with reference to FIG. 4. The customer may use the EVCI 310 stored in the digital wallet application to make payments on online portals, to perform purchase transactions at Point-of-Sale (POS) terminals, to initiate interactions with agents of the enterprise and, in general, engage with an enterprise.

Referring now to FIG. 4, an example representation of a messaging notification 400 is shown for illustrating the addition of an EVCI to a digital wallet application installed in the electronic device of the customer in accordance with an embodiment of the invention.

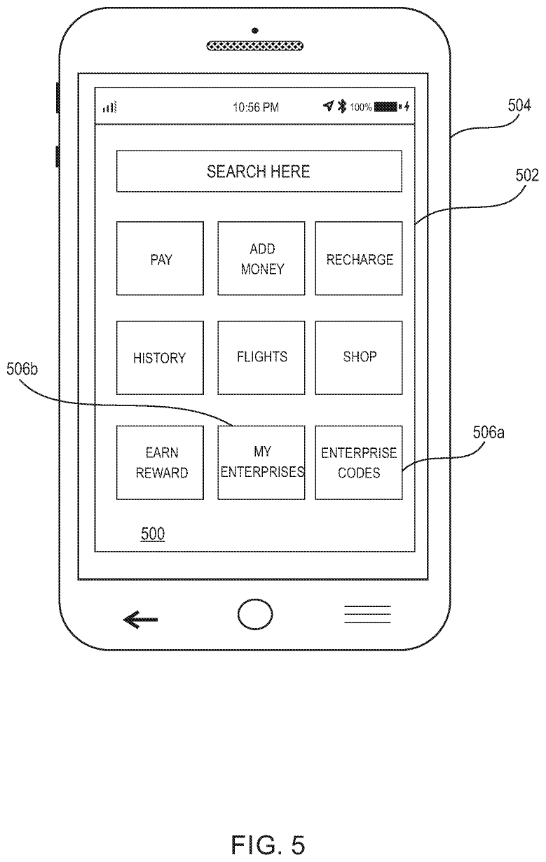

As explained with reference to FIG. 3, the EVCI 310 expressed in the form of a machine readable code, such as the barcode 312 or the QR code 314, may be transmitted by the server system 150 to the electronic device associated with the customer via one or more messaging channels. In one illustrative example, the EVCI 310 may be embedded in the messaging notification 400 provided to the customer on successful completion of the customer registration, as exemplarily shown in FIG. 4. More specifically, the customer may have visited an enterprise website on the Internet and sought to register with the enterprise. On successful completion of the registration process, a messaging notification such as the messaging notification 400 may be displayed to the customer on the display screen of the electronic device used by the customer for accessing the enterprise website and initiating the registration process. The messaging notification 400 is depicted to include a text portion 402, exemplarily depicted to display text ‘CONGRATULATIONS. YOU HAVE SUCCESSFULLY COMPLETED REGISTRATION WITH ENTERPRISE ABC. WELCOME TO THE ABC FAMILY. PLEASE STORE THE CODE SHOWN BELOW IN THE DIGITAL WALLET OF YOUR CHOICE. YOU MAY USE THE CODE TO CONNECT WITH US AGAIN’. The messaging notification 402 may further display an EVCI 404 (depicted to be expressed as a QR code) along with two buttons 406 and 408. The buttons 406 and 408 are exemplarily depicted to display text ‘STORE IN A DIGITAL WALLET’ and ‘GET A DIGITAL WALLET’, respectively. If the customer selects the button 408, the customer may be redirected to a Web page associated with an online application store displaying several options to download a digital wallet application of choice onto the electronic device. If the electronic device includes two or more digital wallet applications, the customer may select the button 406. On selection of the button 406, the customer may be redirected to a UI showing all installed digital wallet applications and the customer may be requested to select one or more digital wallet applications to store the EVCI 404. A user interface (UI) displayed to the customer on selection of a choice of digital wallet application is shown in FIG. 5.

Referring now to FIG. 5, an example representation of a User Interface (UI) 500 associated with a digital wallet application 502 is shown for illustrating the storage of the EVCI in the digital wallet application 502 in accordance with an embodiment of the invention. As explained with reference to FIG. 4, the server system 150 may cause storage of the EVCI in the digital wallet application installed in the electronic device of the customer. More specifically, in FIG. 4, the messaging notification 400 included a request to the customer to store the EVCI 404 in the digital wallet application.

The UI 500 of the digital wallet application 502 is displayed on the electronic device 504 associated with the customer and includes a plurality of actionable buttons. The customer may select an actionable button 506a associated with text ‘Enterprise Codes’ to store one or more EVCIs, such as the EVCI 404 shown in FIG. 4, in the digital wallet application 502. On selection of the actionable button 506a, the customer may be directed to another UI configured to include form fields to allow the customer to enter the enterprise name, select a personalized name for the EVCI and also select the level of authentication for securely storing the EVCI in the digital wallet application 502. The actionable buttons displayed on the UI 500 also include an actionable button 506b associated with text ‘My Enterprises’, which on selection, is configured to cause display names of all the enterprises associated with the customer, i.e. the enterprises for which the customer is a registered user, along with corresponding EVCIs. In at least some embodiments, the customer may select the enterprise name to initiate an engagement with the enterprise using the EVCI.

As can be understood, the messaging notification, such as the messaging notification 400 as explained with reference to FIG. 4, provided by the server system 150 causes the storage of the EVCI, such as the EVCI 404, in the digital wallet application 502 to facilitate customer engagement with the enterprise.

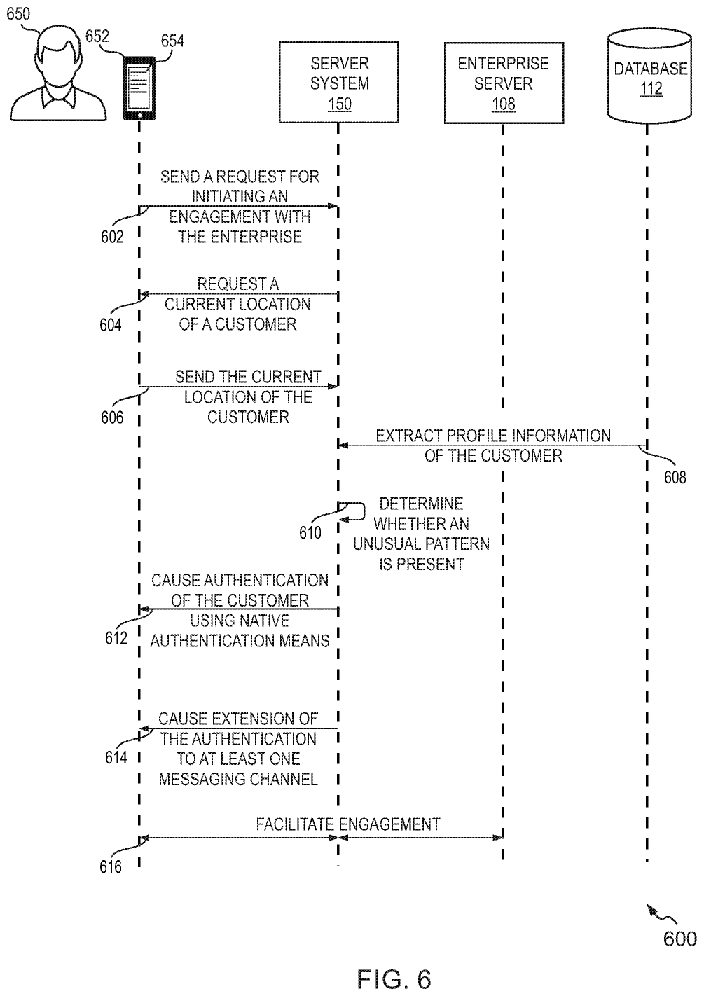

FIG. 6 is a sequence flow diagram 600 illustrating a process for facilitating customer engagement with an enterprise using the EVCI stored in the digital wallet application in accordance with an embodiment of the present invention. The sequence of operations of the sequence flow diagram 600 may not be necessarily executed in the same order as it is presented. Further, one or more operations may be grouped together and performed in form of a single step, or one operation may have several sub-steps that may be performed in parallel or in a sequential manner. The process illustrated by the sequence flow diagram 600 starts at 602.

At 602, the customer 650 uses an electronic device 652 to initiate an engagement with an enterprise (not shown in FIG. 6). The request for initiating the engagement may be received in form of a signal at the server system 150 as the server system 150 is in operable communication with the enterprise, i.e. with an enterprise server 108. The customer 650 may wish to initiate an engagement with the enterprise for a plurality of reasons. In one illustrative example, the customer 650 may wish to perform a payment for a service availed from the enterprise. In another illustrative example, the customer 650 may wish to perform a purchase transaction at a POS terminal at a physical store associated with the enterprise. In yet another illustrative example, the customer 650 may wish to connect with customer service/customer support personnel, i.e. an agent, to troubleshoot an issue with a recently purchased product. Accordingly, the customer 650 may wish to initiate engagement with the enterprise.

The engagement with the enterprise may be initiated in any of several embodiments. For example, the customer 650 may visit the enterprise website by accessing the Internet on the electronic device 652 including the digital wallet application 654 storing the EVCI. On visiting the enterprise website, the customer 650 may select an option to pay a bill. The Web page UI associated with bill payment may check with the customer 650 whether the customer 650 is registered with the enterprise or not and, if yes, may instruct the customer 650 to provide the EVCI. In response to the instruction, the customer 650 may then select the EVCI stored in the digital wallet application 654. The selection of the EVCI may be received in form of signal at the server system 150 and may indicate the customer's need for initiating an engagement with the enterprise. Similarly, the customer 650 may select an option on the enterprise website to connect with an agent to troubleshoot an issue. In response to the selection of the option, the Web page UI associated with enterprise Website may check with the customer 650 whether the customer 650 is registered with the enterprise and, if yes, may instruct the customer 650 to provide the EVCI. In response to the instruction, the customer 650 may then select the EVCI stored in the digital wallet application 654. The selection of the EVCI may be received in form of signal at the server system 150 and may indicate the customer's need for initiating an engagement with the enterprise.

In another illustrative example, the customer 650 may visit a retail outlet and wish to perform a purchase transaction at the POS terminal. The customer 650 may be requested to scan the machine readable code to make the payment. In response to the request, the customer 650 may select the EVCI stored in the digital wallet application 654 and place the EVCI in front of the scanner associated with the POS terminal. The scanning of the EVCI may be received in form of signal at the server system 150 and may indicate the customer's need for initiating an engagement with the enterprise.

At 604, the server system 150 may request a current location of the customer 650 from the electronic device 652. As explained with reference to FIG. 1, the electronic device 652 used by the customer 650 may be a smart device and may include location sensors, such as for example a Global Positioning System (GPS) sensor for tracking current location of the electronic device, i.e. the current location of the customer 650.

At 606, the server system 150 may receive the current location of the customer 650 from the electronic device 652. In some embodiments, the request for initiating engagement with the customer 650 at 602 may include the current location of the customer 650 and the server system 150 may not have to specifically require to request the current location of the customer 650.

At 608, the server system 150 uses the EVCI to extract information related to the profile of the customer 650 from a database 112 associated with the enterprise server 108. Customer attributes, such as usual locations visited by the customer 650, preferred products, time of the day for engaging with the enterprise, type of engagement requests, preferred mode of engagement (whether voice, chat or social media, etc.) may be gathered from the extracted information.

At 610, the server system 150 determines whether an unusual pattern is present in relation to the customer's request for the engagement with the enterprise. In one embodiment, the server system 150 compares the gathered information with the current request for engagement provided by the customer 650. For example, the current location of the customer 650 may be compared with usual locations visited by the customer 650, or the preferred time of the day for engagement may be compared with the current time of request for engagement. If the outcome of the comparison of the one or more attributes is not a match, then the server system 150 determines that the unusual pattern is present in relation to the customer's request for engagement with the enterprise. If the outcome of the comparison of the one or more attributes is a match, then the server system 150 determines that the unusual pattern is absent in relation to the customer's request for engagement with the enterprise.

At 612, the server system 150 causes the authentication of the customer 650 using native authentication implemented on the electronic device 652 for authenticating transactions using digital wallet application 654. More specifically, the usage of digital wallet application 654 may natively include authentication, such as for authenticating at least one of a facial identification (ID), a touch ID, and a One-Time Password (OTP). The server system 150 may use the native authentication of the digital wallet application 654 to authenticate the identity of the customer 650. At 614, the server system 150 is configured to cause extension of the authentication to at least one messaging channel from among the one or more messaging channels associated with the enterprise.

At 616, the customer 650 may be directed to an enterprise messaging channel to facilitate customer engagement with the enterprise. In one illustrative example, the customer 650 may be directed to the enterprise website reserved for registered users, or, the customer 650 may be directed to a chat messaging channel, wherein a virtual agent, i.e. a chat bot, of the enterprise may engage in a chat interaction with the customer 650 to provide desired assistance to the customer 650. Alternatively, in some embodiments, a human agent associated with the enterprise may place a call on the number associated with the customer's electronic device 652 to initiate engagement with the enterprise. In yet another embodiment, the secure messaging channel may correspond to channel associated with a payment gateway for enabling payment for a service availed by the customer 650 or a payment for a purchase transaction at a POS terminal.

In some embodiments, subsequent to the determination of the presence of the unusual pattern, the server system 150 enables the engagement between the customer 650 and the enterprise using a secure messaging channel with added layer of authentication. More specifically, the server system 150 may add an additional layer of authentication, such as an OTP on top of touch ID recognition, to enable secure engagement between the customer 650 and the enterprise.

In at least one embodiment, the server system 150 may also personalize an engagement experience for the customer 650 based, at least in part, on the current location of the customer 650 and one or more customer preferences. Some examples of personalized engagement experience may involve customizing the interaction UI based on customer's preferences, offering interaction over a messaging channel preferred by the customer 650, selecting an agent having similar persona as the customer 650 or an agent trained to handle customer persona to interact with the customer 650, offering product recommendations, and the like. The process illustrated by the sequence flow diagram 600 ends at 616.

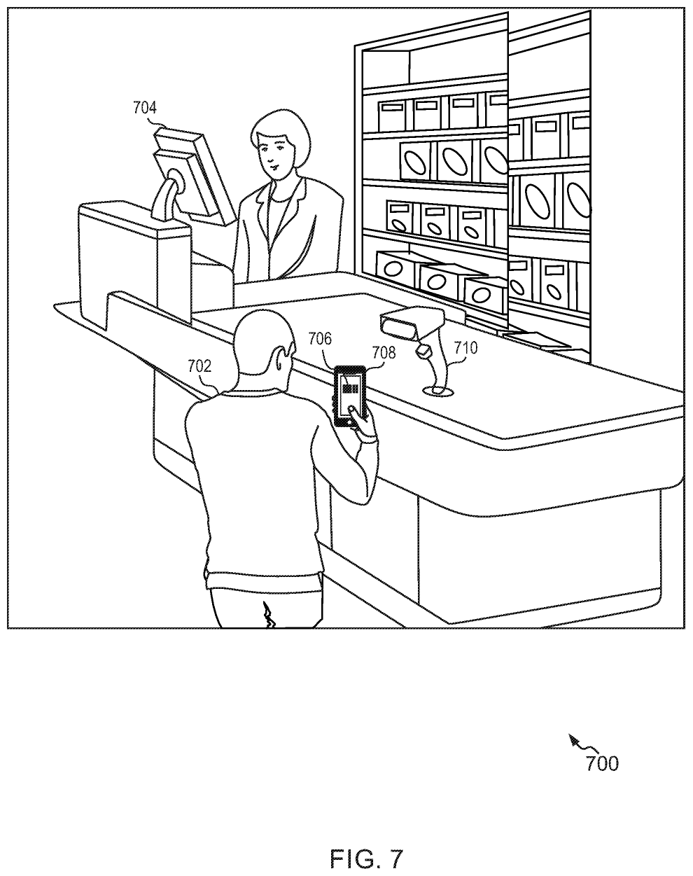

FIG. 7 shows an example representation 700 for illustrating the use of the stored EVCI in facilitating customer engagement with the enterprise in accordance with an embodiment of the invention. More specifically, the representation 700 shows a customer 702 performing a purchase transaction at a POS terminal 704. The customer 702 is depicted to retrieve the EVCI 706 stored in the digital wallet application installed in the electronic device 708 and scan the EVCI 706 at a scanner device 710 associated with the POS terminal 704 to initiate the purchase transaction. The EVCI 706 may be used by the server system 150, shown in FIG. 1, to retrieve payment card information stored in the profile of the customer 702 and forward the payment card information to the payment gateway linked with the POS terminal 704. In at least one embodiment, the native device-level authentication means associated with the digital wallet application may be used to authenticate the customer identity prior to initiating the purchase transaction. Thus, the EVCI 706 stored in the digital wallet application may facilitate engagement with the enterprise over an enterprise retail channel.

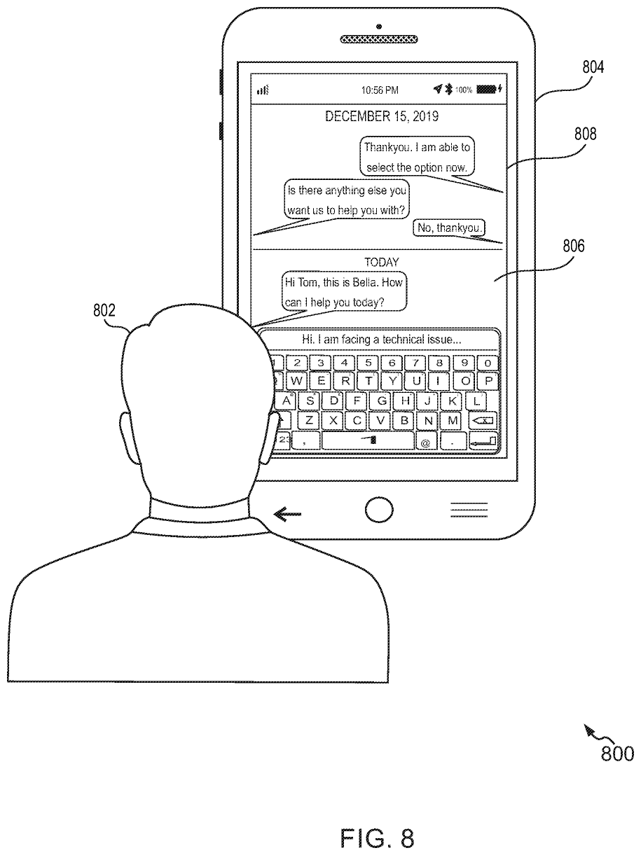

FIG. 8 shows an example representation 800 for illustrating the use of the stored EVCI in facilitating customer engagement with the enterprise in accordance with another embodiment of the invention. In an example scenario, the customer 802 may wish to interact with a customer service personnel, i.e. an agent, of the enterprise for troubleshooting a technical issue with a recently purchased product from the enterprise. To that effect, the customer 802 may visit the enterprise Website by accessing the Internet on the electronic device 804 including the digital wallet application storing the EVCI. On visiting the enterprise Website, the customer 802 may select an option on the enterprise Website to connect with an agent to troubleshoot the technical issue. In response to the selection of the option, the Web page UI associated with enterprise Website may check with the customer 802 whether the customer 802 is registered with the enterprise and, if yes, may instruct the customer 802 to provide the EVCI. In response to the instruction, the customer 802 may then select the EVCI stored in the digital wallet application. The selection of the EVCI may be received in form of signal at the server system 150 and may indicate the customer's need for initiating an engagement with the enterprise. In at least one embodiment, the native device-level authentication means associated with the digital wallet application may be used to authenticate the customer identity prior to initiating the interaction. On successful authentication, the server system 150 may cause display of a UI, such as the UI 806 associated with a chat application 808 for connecting with the customer 802 and providing the desired assistance to the customer 802. Thus, the EVCI stored in the digital wallet application may facilitate engagement with the enterprise over an enterprise chat channel.

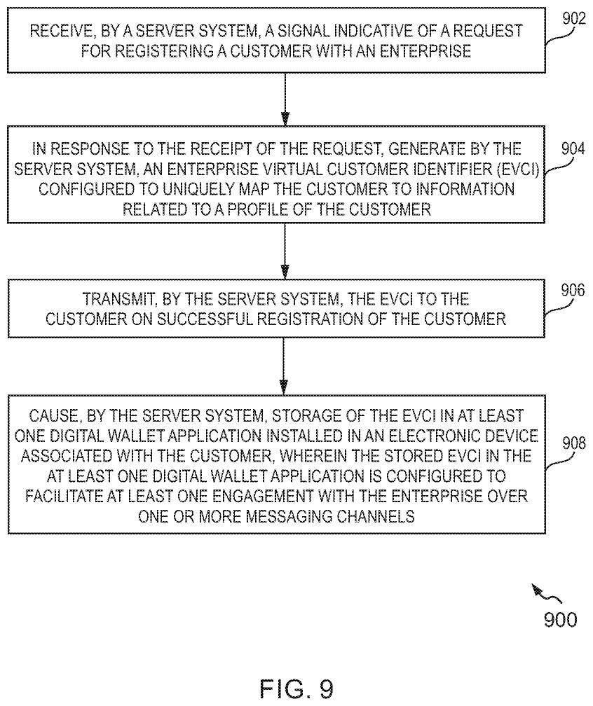

FIG. 9 illustrates a flow diagram of a method 900 for facilitating customer engagement with an enterprise in accordance with an embodiment of the invention. The method 900 depicted in the flow diagram may be executed by, for example, the server system 150 of FIG. 1. Operations of the method 900, and combinations of operation in the method 900, may be implemented by, for example, hardware, firmware, a processor, circuitry and/or a different electronic device associated with the execution of software that includes one or more computer program instructions. The method 900 starts at operation 902.

At operation 902, a signal indicative of a request for registering a customer with an enterprise is received by a server system, such as the server system 150. In an illustrative example, the customer may be an existing or a potential customer of products, services and/or information offered by the enterprise and, accordingly, may wish to register with the enterprise. To that effect, the customer may use an electronic device to access an enterprise website or an enterprise mobile application, and fill out one or more registration form fields with information, such as the customer's name, address, age, sex, payment card information, preferences, contact information, etc. Such information provided by the customer may be embodied in form of a signal and sent to the enterprise server for registering the identity of the customer.

If the customer has previously purchased products of the enterprise or interacted with agents of the enterprise, such information may be stored in the database, such as the database 112 shown in FIG. 1, associated with the enterprise. On receiving the signal indicative of the customer's request for registration, the information provided by the customer may be added to the stored information to create a profile of the customer. In other words, a profile of the customer may be generated as part of the registration process. If the customer is a new user, the information provided by the customer 106 may be used to create the profile of the customer. The created profile of the customer may include content, such as information related to at least one of the customer's personal information, products owned by the customer, services undertaken by the customer, one or more locations associated with the customer, one or more customer preferences, interactions of the customer with enterprise website and with agents of the enterprise. The server system, on account of being in operative communication with the enterprise server, may receive the signal indicative of the customer's request for registration. The enterprise server may also communicate the successful completion of the customer registration process and a pointer to the profile of the customer to the server system.

At operation 904, an enterprise virtual customer identifier (EVCI) configured to uniquely map the customer to the information related to a profile of the customer is generated by the server system. In an embodiment, the EVCI is expressed in form of a bar code, a Quick Response (QR) code, or a Near Field Communication (NFC) tag. The generation of the EVCI may be performed as explained with reference to FIG. 3 and is not explained again herein.

At operation 906, the EVCI is transmitted along the notification of the successful registration to the electronic device of the customer. The EVCI is transmitted to the customer using at least one of a Short Message Service (SMS), an Electronic Mail (E-mail), a mobile application notification and an instant messaging notification. The transmission of the EVCI may be performed as explained with reference to FIG. 4 and is not explained again herein.

At operation 908, storage of the EVCI in at least one digital wallet application installed in an electronic device associated with the customer is caused by the server system. The storage of the EVCI in the digital wallet application may be caused by the server system as explained with reference to FIG. 5 and is not explained again herein. The stored EVCI in the digital wallet application is configured to facilitate at least one engagement with the enterprise over one or more messaging channels. Some non-limiting examples of the messaging channels include a chat messaging channel, a voice interaction channel, an enterprise website, an Interactive Voice Response (IVR) interaction channel, and a social media messaging channel. Some examples of customer engagement facilitated by the EVCI is explained with reference to FIGS. 7 and 8.

In one embodiment, the customer may wish to initiate an engagement with an enterprise. The request for initiating the engagement may be received in form of a signal at the server system as the server system is in operable communication with the enterprise. The customer may wish to initiate an engagement with the enterprise for a plurality of reasons as outlined in FIG. 6. The server system may request a current location of the customer from the electronic device and, on receipt of the current location of the customer from the electronic device, the server system may use the EVCI to extract information related to the profile of the customer from a database associated with the enterprise server. Customer attributes, such as usual locations visited by the customer, preferred products, time of the day for engaging with the enterprise, type of engagement requests, preferred mode of engagement, whether voice, chat or social media, etc., may be gathered from the extracted information. The server system may then be configured to determine the presence of an unusual pattern in relation to the customer's request for the engagement with the enterprise. In one embodiment, the server system compares the gathered information with the current request for engagement provided by the customer. For example, the current location of the customer may be compared with usual locations visited by the customer or preferred time of the day for engagement may be compared with the current time of request for engagement. If the outcome of the comparison of the one or more attributes is not a match, then the server system determines that the unusual pattern is present in relation to the customer's request for engagement with the enterprise. If the outcome of the comparison of the one or more attributes is a match, then the server system determines that the unusual pattern is absent in relation to the customer's request for engagement with the enterprise.

The server system causes the authentication of the customer using native authentication implemented on the electronic device for authenticating transactions using digital wallet application. More specifically, the usage of digital wallet application may natively include authentication, such as for authenticating at least one of a facial identification (ID), a touch ID, and a One-Time Password (OTP). The server system 150 may use the native authentication of the digital wallet application to authenticate the identity of the customer. The server system is further configured to cause extension of the authentication to at least one messaging channel associated with the enterprise. In one embodiment, the customer may be directed to an enterprise messaging channel facilitate customer engagement with the enterprise. In one illustrative example, the customer may be directed to the enterprise website reserved for registered users, or, the customer may be directed to a chat messaging channel, wherein a virtual agent, i.e. a chat bot, of the enterprise may engage in a chat interaction with the customer to provide desired assistance to the customer. Alternatively, in some embodiments, a human agent associated with the enterprise may place a call on the number associated with the customer's electronic device to initiate engagement with the enterprise. In yet another embodiment, the secure messaging channel may correspond to channel associated with a payment gateway for enabling payment for a service availed by the customer or a payment for a purchase transaction at a POS terminal.

Further, subsequent to the determination of the presence of the unusual pattern, the server system may enable the engagement between the customer and the enterprise using a secure messaging channel with added layer of authentication. More specifically, the server system may add an additional layer of authentication, such as an OTP, on top of touch ID recognition to enable secure engagement between the customer and the enterprise. In at least one embodiment, the server system may also personalize an engagement experience for the customer based, at least in part, at least in part, on the current location of the customer and one or more customer preferences. Some examples of personalized engagement experience may involve customizing the interaction UI based on customer's preferences, offering interaction over a messaging channel preferred by the customer, selecting an agent having similar persona as the customer or an agent trained to handle customer persona to interact with the customer, offering product recommendations, and the like.

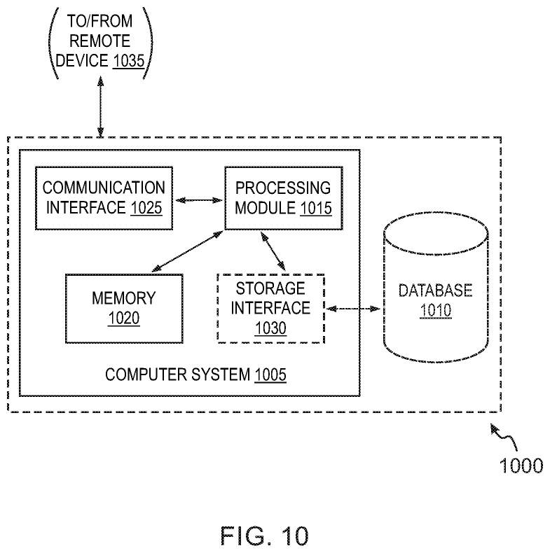

FIG. 10 illustrates a block diagram representation of a server system 1000, which is capable of implementing various embodiments of the present invention. More specifically, the server system 1000 is capable of generating EVCIs for a plurality of customers of the enterprises and enabling the storage of the EVCIs in the digital wallet applications installed in the respective electronic devices of the customers for facilitating customer engagement with the enterprises. An example of the server system 1000 is the server system 150 as shown and described with reference to FIGS. 1 to 8. In FIG. 10, the server system 1000 is depicted to include several components. The components may use hardware elements, software elements, firmware elements and/or a combination thereof.

In an embodiment, the server system 1000 includes a computer system 1005 and a database 1010. The computer system 1005 includes at least one processing module 1015 for executing instructions stored in a memory 1020. The processing module 1015 may include one or more processing units, e.g. in a multi-core configuration. In an embodiment, the processing module 1015 is configured to generate enterprise virtual customer identifiers (EVCI) for customers of one or more enterprises. The processing module 1015 may generate an EVCI for a customer in response to a receipt of a request for registering the customer with an enterprise. Alternatively, the processing module 1015 may generate an EVCI for even a non-registered customer, who has previously engaged with the enterprise or is currently engaged in interaction with the enterprise. The processing module 1015 is also configured to link the generated EVCI with the information related to the profile of the customer. Additionally, the processing module 1015 may cause storage of the EVCI in at least one digital wallet application installed in the electronic device of the customer. In at least one embodiment, the processing module 1015 is also configured to cause authentication of the customer using native authentication means and to extend the authentication to at least one messaging channel installed on the electronic device to facilitate customer engagement with the enterprise.

The processing module 1015 is further configured to personalize an engagement experience for the customer based on the current location of the customer and one or more customer preferences. In some embodiments, the processing module 1015 is also configured to detect presence of an unusual pattern in relation to the customer's request for the engagement with the enterprise, and to enable the engagement between the customer and the enterprise using a secure messaging channel with added layer of authentication if the unusual pattern is detected to be present.

The processing module 1015 is operatively coupled to a communication interface 1025 such that the computer system 1005 is capable of communicating with a remote device 1035 or with any entity over a communication network, such as the communication network 120 shown in FIG. 1, via the communication interface 1025. Some non-limiting examples of the remote device 1035 include electronic devices of the customers, enterprise servers, databases associated with the enterprise servers, and the like. For instance, the communication interface 1025 is capable of receiving a signal indicative of a request for customer registration, a signal indicative of a request for engaging with the enterprise, and a current location of the customer. The communication interface 1025 is also configured to transmit the EVCI to an electronic device associated with a customer. In at least some embodiments, the communication interface 1025 communicates with the remote device 1035 via API calls.

The processing module 1015 may also be operatively coupled to the database 1010. The database 1010 may be a computer-operated hardware suitable for storing and/or retrieving data, such as, but not limited to, customer EVCIs, profile information of the customers, enterprise IDs, and the like. The database 1010 may include multiple storage units such as hard disks and/or solid-state disks in a redundant array of inexpensive disks (RAID) configuration. The database 1010 may include a storage area network (SAN) and/or a network attached storage (NAS) system. In some alternate embodiments, the database 1010 may also include magnetic storage devices such as hard disk drives, floppy disks, magnetic tapes, etc.; optical magnetic storage devices, e.g. magneto-optical disks; and semiconductor memories such as mask ROM, PROM (programmable ROM), EPROM (erasable PROM), Phase-change memory, flash ROM, RAM (random access memory), etc.

In some embodiments, the database 1010 is integrated within the computer system 1005. For example, the computer system 1005 may include one or more hard disk drives as the database 1010. In other embodiments, the database 1010 is external to the computer system 1005 and may be accessed by the computer system 1105 using a storage interface 1030. The storage interface 1130 is any component capable of providing the processing module 1015 with access to the database 1010. The storage interface 1030 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processing module 1015 with access to the database 1010.

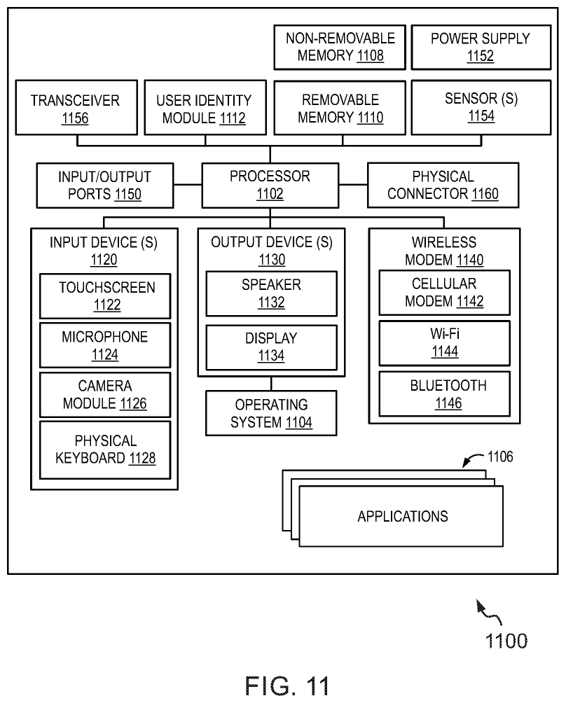

FIG. 11 illustrates an electronic device 1100, such as the electronic device 114 of FIG. 1 capable of implementing some embodiments of the present invention. The electronic device 1100 as illustrated and hereinafter described is merely illustrative of one type of electronic device and should not be taken to limit the scope of the embodiments. As such, at least some of the components described below in connection with the electronic device 1100 may be optional and thus in an example embodiment may include more, less or different components than those described in connection with the example embodiment of the FIG. 11. As such, among other examples, the electronic device 1100 could be any of the smart electronic devices, for example, smart phones, tablet computers, laptops, mobile computers, desktop computers, personal digital assistants (PDAs), smart wearables, Augmented Reality (AR)/Virtual Reality (VR) devices, or any combination of the aforementioned, and other types of communication or multimedia devices.

The illustrated electronic device 1100 includes a controller or a processor 1102, e.g. a signal processor, microprocessor, ASIC, or other control and processing logic circuitry, for performing tasks such as signal coding, data processing, image processing, input/output processing, power control, and/or other functions. An operating system 1104 controls the allocation and usage of the components of the electronic device 1100 and supports for one or more application programs (see, applications 1106), such as the digital wallet application 116, that implements one or more of the innovative features described herein. In addition to the digital wallet application, the applications 1106 may include common mobile computing applications, e.g. telephony applications, email applications, calendars, contact managers, web browsers, messaging applications, or any other computing application.

The illustrated electronic device 1100 includes one or more memory components, for example, a non-removable memory 1108, and/or removable memory 1110. The non-removable memory 1108 can include RAM, ROM, flash memory, a hard disk, or other well-known memory storage technologies. The removable memory 1110 can include flash memory, smart cards, or a Subscriber Identity Module (SIM). The memory components can be used for storing data and/or code for running the operating system 1104 and the applications 1106. The electronic device 1100 may further include a user identity module (UIM) 1112. The UIM 1112 may be a memory device having a processor built in. The UIM 1112 may include, for example, a subscriber identity module (SIM), a universal integrated circuit card (UICC), a universal subscriber identity module (USIM), a removable user identity module (R-UIM), or any other smart card. The UIM 1112 typically stores information elements related to a mobile subscriber. The UIM 1112 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1100 can support one or more input devices 1120 and one or more output devices 1130. Examples of the input devices 1120 may include, but are not limited to, a touchscreen 1122, e.g. capable of capturing finger tap inputs, finger gesture inputs, multi-finger tap inputs, multi-finger gesture inputs, or keystroke inputs from a virtual keyboard or keypad), a microphone 1124, e.g. capable of capturing voice input, a camera module 1126, e.g. capable of capturing still picture images and/or video images or capturing an OCR image of a picture, and a physical keyboard 1128. Examples of the output devices 1130 may include, but are not limited to, a speaker 1132 and a display 1134. Other possible output devices (not shown in the FIG. 11) can include piezoelectric or other haptic output devices. Some devices can serve more than one input/output function. For example, the touchscreen 1122 and the display 1134 can be combined into a single input/output device.

A wireless modem 1140 can be coupled to one or more antennas (not shown in the FIG. 11) and can support two-way communications between the processor 1102 and external devices, as is well understood in the art. The wireless modem 1140 is shown generically and can include, for example, a cellular modem 1142 for communicating at long range with the mobile communication network, a Wi-Fi compatible modem 1144 for communicating at short range with an external Bluetooth-equipped device or a local wireless data network or router, and/or a Bluetooth-compatible modem 1146. The wireless modem 1140 is typically configured for communication with one or more cellular networks, such as a GSM network for data and voice communications within a single cellular network, between cellular networks, or between the electronic device 1100 and a public switched telephone network (PSTN).

The electronic device 1100 can further include one or more input/output ports 1150, a power supply 1152, one or more sensors 1154 for example, an accelerometer, a gyroscope, a compass, or an infrared proximity sensor for detecting the orientation or motion of the electronic device 1100, a transceiver 1156 for wirelessly transmitting analog or digital signals, and/or a physical connector 1160, which can be a USB port, IEEE 1294 (FireWire) port, and/or RS-232 port. The illustrated components are not required or all-inclusive, as any of the components shown can be deleted and other components can be added.

In at least one embodiment, the electronic device 1100 is configured to receive an enterprise virtual customer identifier (EVCI) from a server system, such as the server system 150 of FIG. 1, associated with an enterprise. The electronic device 1100 may receive the EVCI using the transceiver 1156. The electronic device 1100 may further be caused to store the EVCI in at least one digital wallet application installed in the electronic device 1100. The electronic device 1100 may receive an input from the customer for retrieving the stored EVCI for initiating an engagement with the enterprise. The input may be received using at least one of the input devices 1120. In response to the input, the processor 1102 in conjunction with the stored instructions may authenticate the customer using native authentication means implemented on the electronic device 1100 for authenticating transactions using the digital wallet application. The electronic device 1100 may further be caused to facilitate the engagement with the enterprise over one or more messaging channels subsequent to successful authentication of the customer as explained with reference to the customer electronic devices in FIGS. 1 to 8.

The disclosed methods or one or more operations of the flow diagram of the method 900 and/or the sequence flow diagrams 200 and 600 disclosed herein may be implemented using software including computer-executable stored on one or more computer-readable media, e.g. non-transitory computer-readable media, such as one or more optical media discs; volatile memory components, e.g. DRAM or SRAM; or nonvolatile memory or storage components, e.g. hard drives or solid-state nonvolatile memory components, such as Flash memory components and executed on a computer, e.g., any suitable computer, such as a laptop computer, net book, Web book, tablet computing device, smart phone, or other mobile computing device. Such software may be executed, for example, on a single local computer or in a network environment, e.g. via the Internet, a wide-area network, a local-area network, a remote web-based server, a client-server network such as a cloud computing network, or other such network, using one or more network computers. Additionally, any of the intermediate or final data created and used during implementation of the disclosed methods or systems may also be stored on one or more computer-readable media, e.g. non-transitory computer-readable media, and are considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable including fiber optic cable, magnetic communications, electromagnetic communications including RF, microwave, and infrared communications, mobile communications, or other such communication means.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a server system, a signal indicative of a request for registering a customer with an enterprise;
in response to the receipt of the request, generating by the server system, an enterprise virtual customer identifier (EVCI) configured to uniquely map the customer to information related to a profile of the customer;
upon successful registration of the customer, transmitting by the server system, the EVCI to the customer; and
causing, by the server system, storage of the EVCI in at least one digital wallet application installed in an electronic device associated with the customer, wherein the stored EVCI in the at least one digital wallet application is configured to facilitate at least one engagement with the enterprise over one or more messaging channels.

2. The method of claim 1, wherein the EVCI is represented as at least one of a bar code, a Quick Response (QR) code, and a Near Field Communication (NFC) tag.

3. The method of claim 1, further comprising:
receiving, by the server system, a request for initiating an engagement with the enterprise, the request initiated using the EVCI stored in the at least one digital wallet application installed in the electronic device associated with the customer;
causing, by the server system, authentication of the customer using native authentication implemented on the electronic device for authenticating transactions using the at least one digital wallet application; and
extending, by the server system, the authentication to at least one messaging channel from among the one or more messaging channels for facilitating the engagement of the customer with the enterprise.

4. The method of claim 3, further comprising:
initiating the engagement with the enterprise in relation to one of a payment transaction via a messaging channel, a purchase transaction at a point-of-sale (POS) terminal, and an interaction sought with an agent associated with the enterprise.

5. The method of claim 3, wherein the native authentication comprises authenticating at least one of a facial identification (ID), a touch ID ,and a One-Time Password (OTP).

6. The method of claim 3, further comprising:
receiving, by the server system, a current location of the customer from the electronic device;
extracting, by the server system, one or more customer preferences related to the customer based on the EVCI; and
personalizing, by the server system, an engagement experience for the customer based, at least in part, on the current location of the customer and the one or more customer preferences.

7. The method of claim 3, further comprising:
detecting, by the server system, presence of an unusual pattern in relation to the customer's request for initiating the engagement with the enterprise; and
subsequent to the detection of the presence of the unusual pattern, enabling by the server system, the engagement between the customer and the enterprise using a secure messaging channel with an added layer of authentication.

8. The method of claim 1, further comprising:
transmitting the EVCI to the customer using one of a Short Message Service (SMS), an Electronic Mail (E-mail), a mobile application notification, and an instant messaging notification.

9. The method of claim 1, wherein at least one messaging channel from among the one or more messaging channels corresponds to a chat messaging channel, a voice interaction channel, an enterprise website, an Interactive Voice Response (IVR) interaction channel, and a social media messaging channel.

10. The method of claim 1, wherein the profile of the customer comprises information related to at least one of the customer's personal information, products owned by the customer, services undertaken by the customer, one or more locations associated with the customer, one or more customer preferences, and interactions of the customer with an enterprise website and with agents of the enterprise.

11. A server system, comprising:
a memory for storing instructions; and
a processing module configured to execute the instructions and thereby cause the server system to:
receive a signal indicative of a request for registering a customer with an enterprise;
in response to the receipt of the request, generate an enterprise virtual customer identifier (EVCI) configured to uniquely map the customer to information related to a profile of the customer;
upon successful registration of the customer, transmit the EVCI to the customer; and
cause storage of the EVCI in at least one digital wallet application installed in an electronic device associated with the customer, wherein the stored EVCI in the at least one digital wallet application is configured to facilitate at least one engagement with the enterprise over one or more messaging channels.

12. The server system of claim 11, wherein the EVCI is represented as one of a bar code, a Quick Response (QR) code, and a Near Field Communication (NFC) tag.

13. The server system of claim 11, wherein the server system is further caused to:
receive a request for initiating an engagement with the enterprise, the request initiated using the EVCI stored in the at least one digital wallet application installed in the electronic device associated with the customer;
cause authentication of the customer using native authentication implemented on the electronic device for authenticating transactions using the at least one digital wallet application; and
extend the authentication to at least one messaging channel from among the one or more messaging channels for facilitating the engagement of the customer with the enterprise.

14. The server system of claim 13, wherein the engagement with the enterprise is initiated in relation to one of a payment transaction via a messaging channel, a purchase transaction at a point-of-sale (POS) terminal, and an interaction sought with an agent associated with the enterprise.

15. The server system of claim 13, wherein the native authentication comprises authenticating at least one of a facial identification (ID), a touch ID, and a One-Time Password (OTP).

16. The server system of claim 13, wherein the server system is further caused to:
receive a current location of the customer from the electronic device;
extract one or more customer preferences related to the customer based on the EVCI; and
personalize an engagement experience for the customer based, at least in part, on the current location of the customer and the one or more customer preferences.

17. The server system of claim 13, wherein the server system is further caused to:
detect presence of an unusual pattern in relation to the customer's request for initiating the engagement with the enterprise; and
subsequent to the detection of the presence of the unusual pattern, enable the engagement between the customer and the enterprise using a secure messaging channel with an added layer of authentication.

18. An electronic device, comprising:
a memory for storing instructions; and
a processor configured to execute the instructions and thereby cause the electronic device to at least:
receive an enterprise virtual customer identifier (EVCI) sent from a server system associated with an enterprise;
store the EVCI in at least one digital wallet application installed in the electronic device;
receive an input from the customer for retrieving the stored EVCI for initiating an engagement with the enterprise;
in response to the input, authenticate the customer using native authentication implemented on the electronic device for authenticating transactions using the at least one digital wallet application; and
facilitate the engagement with the enterprise over one or more messaging channels subsequent to successful authentication of the customer, wherein the authentication is extended to at least one messaging channel from among the one or more messaging channels for facilitating the engagement of the customer with the enterprise.

19. The electronic device of claim 18, wherein the native authentication comprises authenticating at least one of a facial identification (ID), a touch ID, and a One-Time Password (OTP).

20. The electronic device of claim 18, wherein the EVCI is represented as one of a bar code, a Quick Response (QR) code, and a Near Field Communication (NFC) tag.
